(19) United States
(12) Patent Application Publication
(10) Pub. No.: US 2007/0180759 A1
(43) Pub. Date: Aug. 9, 2007

(54) Quick and safe release of candle fragrance

(76) Inventor: Bart Kennington, Layton, UT (US)

Correspondence Address: Lynn G. Foster, 602 East 300 South, Salt Lake City, UT, 84102, US

(21) Appl. No.: 11/350,203

(22) Filed: Feb. 8, 2006

(51) Int. Cl. C11C 5/00

(52) U.S. Cl. 44/275

(57) ABSTRACT

This application discloses methodology and several devices by which a fragrance-emitting tunnel is fashioned in a body of candle material in a container, whereby when heat is applied to the bottom or side of the container, fragrance is rapidly released from melted candle material to travel almost instantly along the tunnel to the surrounding ambient environment, while reducing the risk of an explosion or splatter discharge due to rapid gaseous release through the unmelted candle material.

### FIELD OF INVENTION

The present invention relates generally to rapid and safe emission of fragrance from a candle or candle material and, more particularly, to novel formation of a tunnel in the candle material so that when a normally solid body of candle material in a receptacle or container is melted at the bottom or side thereof by heat applied through the receptacle fragrance is almost instantaneously released from the melted candle material along the tunnel to the ambient environment, in such a way as to avoid splatter of melted candle material into the ambient environment.

### BACKGROUND

Perfumed candles and like fragrance releasing items in a solid state at room temperature are typically placed in a container, such as an open top glass vessel. Fragrance is emitted from the material comprising the candle or like item by either burning a wick to melt the top of the candle, or externally heating the bottom of the container to melt the lower portions of the candle or like object.

Wick burning releases pollutants, which to some extent mutes the perfume fragrance also being released, and, with some candle compositions, can be harmful to health.

Non-uniform heating of the material from which the candle or like item is made can result in an explosion, risking human injury, soiling the region surrounding the candle and destroying the assembly, including the container, when glass, for example.

### BRIEF SUMMARY AND OBJECTS OF THE INVENTION

In brief summary, the present invention overcomes or alleviates problems pertaining to the release of fragrance from and/or the melting of candles and the like. A fragrance emitting tunnel is fashioned in the material from which the containerized candle or like item is made, whereby when heat applied to the bottom or side of the container fragrance is rapidly released from melted candle material to travel instantly along the tunnel to ambient environment while reducing the risk of an explosion or splatter due to rapid gaseous release through the unmelted candle material.

With the foregoing in mind, it is a primary object to overcome or alleviate problems of the past pertaining to quiet and safe release of fragrance from candle material.

Another valuable object is the provision of novel formations of tunnels in candle material for rapid and safe fragrance release.

A further paramount object is the provision of novel devices for forming fragrance releasing tunnels in candle material.

These and other objects and features of the present invention will be apparent from the detailed description taken with reference to accompanying drawings.

### BRIEF SUMMARY AND OBJECTS OF THE INVENTION

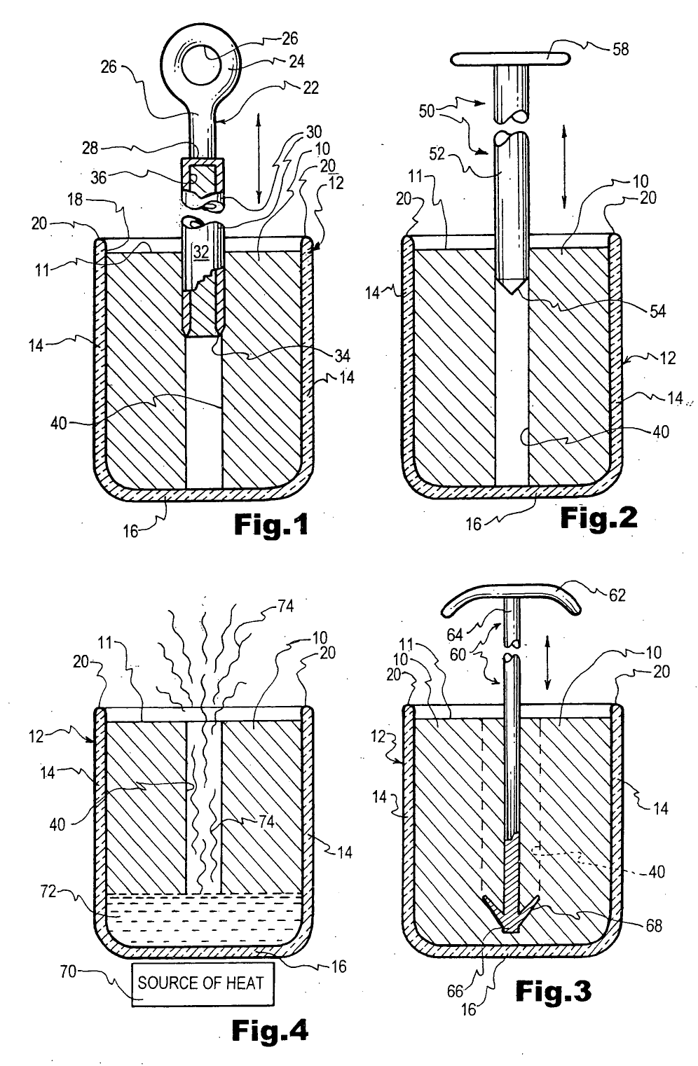

FIG. 1 is a vertical cross section of containerized candle material and a first device for forming a tunnel in the candle material;

FIG. 2 is a vertical cross section of containerized candle material and a second device for forming a tunnel in the candle material;

FIG. 3 is a vertical cross section of containerized candle material and a third device for forming a tunnel in the candle material; and

FIG. 4 is a vertical cross section of containerized and tunnelized candle material being heated for rapid and safe flameless fragrance release along a chimney or tunnel formed in the candle material.

### DETAILED DESCRIPTION OF THE ILLUSTRATED EMBODIMENTS

The present invention provides for rapid and safe emission of fragrance from the candle or candle material, using a novelly-formed, more or less axially-directed tunnel in the candle material, so that when the tunnelized solid body of candle material in a receptacle or container is melted at the bottom or side thereof by heat applied externally through the receptacle or container, fragrance is almost instantaneously released from the melted candle material adjacent to the source of heat along the tunnel to the ambient environment surrounding the candle or candle material, in such a way as to avoid splatter of melted candle material due to an explosion or eruption where the candle material is not vented.

Reference is made to FIG. 1, which illustrates in cross-section, one methodology and tunneling device, by which a tunnel or chimney is formed in a containerized body of candle material, with or without a wick. More specifically, as illustrated in FIG. 1, a solid body 10 of candle material is illustrated as being disposed in a vertically-oriented receptacle or container 12, illustrated as being formed of glass, although other materials, including plastic and metal, could be used to containerize the body of candle material 10. The container 12 comprises an annular sidewall 14, formed as one piece, with a horizontal bottom wall 16, and comprising an open top at 18, adjacent to a top edge 20, illustrated as being contained within a horizontal plane.

FIG. 1 also illustrates a tunneling or chimney-forming mechanism, generally designated 22. Tunneling device 22 comprises an upper handle 24, to be manually grasped by the user. Handle 24 is illustrated as comprising an eyelet comprised of an aperture 26, designed to receive a finger of the user to assist in retracting the device 22, after insertion into the body of candle material 10. Eyelet handle 24 merges as one piece into a solid stem 26, which in turn is intricately connected at site 28 to a diametrally enlarged hollow annular chamber-defining distal end 30 of the tunneling device 22. Distal end 30 comprises an exterior surface 32 of annular configuration, defining a diameter equal to the desired diameter of the tunnel or chimney to be formed in the body of candle material 10. Annular surface 32 terminates in a lower distal edge 34, which may be tapered or beveled to assist in insertion thereof into and along the body of candle material 10. Distal end 30 also forms an entry site into a hollow interior chamber 36, the length of which may be selected by those skilled in the art to accommodate removal of all of the material tunneled by device 22 from the body of candle material 10, in the manner described hereinafter.

While tunneling devices comprised of moving parts may be utilized, those disclosed do not comprise moving parts. Thus, tunneling device 22 is utilized by grasping the handle 24 and placing the distal cutting edge 34 in contiguous relation with the top surface 11 of the body of candle material 10. Thereafter, the user applies manual pressure to the handle 26, displacing the cutting edge 34 downwardly, generally in an axially-directed or vertical manner in and along the body of candle material 10 until the edge 34 is near or contiguous with the bottom surface 16 of the container 12.

Such displacement of the device 22 causes candle material to enter at edge 34 and fill the chamber 36 of the device 22 and to thereby create the tunnel or chimney 40 in the body of candle material 10. The tunnel 40 is illustrated as being essentially in the center of the candle material 10. However, it is to be understood that a central location for the chimney or tunnel 40 is not mandated by the present invention. In other words, the tunnel may be disposed eccentric to the central axis of the material 10. While the tunnel or chimney 40 needs to extend from the top 11 to at or near the bottom 16 of the container 12 it is not strictly essential that it be disposed parallel to the annular sidewall 14 of the container 12. In other words, while generally vertical, it can be disposed at an angle to the vertical to the extent such is accommodated by the container 12.

Reference is now made to FIG. 2, wherein like numerals are used to designate like parts, when compared to FIG. 1, the essential difference being utilization of a different device for creating the tunnel or chimney 40. Specifically, the FIG. 2 illustrates a solid, elongated rod-like tunneling device 50, comprised of a slender central body of solid material 52, a bevel-pointed distal tip 54, and a disc-shaped proximal handle 56. The length of the central elongated cylindrical rod 52 is selected to ensure sufficient length to form tunnel 40 in the solid body of candle material 10. In use, the device 50 is held in the hand of the user at handle 56, located in a generally vertical direction such that the distal tip 54 is contiguous with the top surface 11 of the body of the candle material 10. The user then applies downward manual force to the handle 56, causing the tip 54 and the central rod-like portion 52 to be displaced downwardly until the tip 54 becomes contiguous with or adjacent to the bottom 16 of the container 12, thereby forming the chimney or tunnel 40, by displacing solid candle material outwardly in a somewhat radial direction. The user then pulls on the handle 56 to retract and remove the device 50 from the body of candle material 10, leaving the chimney or tunnel 40 within the solid candle material 10.

Reference is now made to FIG. 3, which shows an additional device by which a tunnel or chimney 40 may be formed in containerized candle material 10. No further description is needed in conjunction with FIG. 3 as to the container and the body of candle material, as such, would be redundant to the presentation above. With continued reference to FIG. 3, a tunneling device 60 is illustrated as comprising an elevated curved top handle 62, which merges with an elongated solid rod 64. The rod 64 terminates in a distal end 66, comprised of an annular barb 68. Device 60 is used in a manner somewhat similar to the use of device 50, as described above. More specifically, the user manually grasps handle 62, orients the device 66 in a generally vertical direction, and applies force to the handle 62, which displaces the device 60 in a downwardly direction, causing the distal end 66 to be located within the material 10 contiguous with or adjacent to the bottom of 16. Thereafter, the user pulls on handle 62 to remove the tunneling device 60 from the body of candle material 10, with the annular barb 68 pulling material directly above the barb 68 upwardly to form the chimney or tunnel 40. The excess material displaced by the barb 68 upon retraction of the device 60, may be left on the top 11 of the body of material 10 or, in the alternative, saved or discarded.

Reference is now made to FIG. 4. When heat is applied from source 70, solid candle material 10 adjacent to the heat melts, as shown at location 72, with the vapor-like fragrance 74, released from the melted candle warming material, passing almost instantaneously up the chimney or tunnel 40 into the ambient environment surrounding the container 12. There is no splatter of melted candle material into the ambient environment caused by eruptions within the candle material 10.

After candle material 10 within the container 12 is entirely melted to gain release of the fragrance, the tunnel 40 no longer exists. Once the candle material thereafter solidifies, through cooling, it can again be tunnelized in the manner described above.

The invention may be embodied in other specific forms without departing from the spirit of the central characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A method for safely and facilely creating a rapid fragrance release from a normally solid: fragrance bearing material, comprising the acts of:
providing a containerized solid body of solid fragrance-laden candle material having a top portion and a bottom portion, with or without a wick;
creating a hollow tunnel in the solid body of candle material the hollow tunnel extending between the top and bottom portions.
applying heat to the candle material sufficient to melt some of the solid candle material; releasing at an early point in time fragrance from the melted candle material up the tunnel and into the surrounding ambient environment.

2. A method according to claim 1 wherein the creating act comprises removing a solid plug from the solid candle material using a hollow probe.

3. A method according to claim 1 wherein the creating act comprises cutting and removing the plug using a probe.

4. A method according to claim 3 wherein the cutting occurs during insertion.

5. A method according to claim 3 wherein the removing occurs during retraction.

6. A method according to claim 1 wherein the creating act comprises displacing solid candle material using a solid probe.

7. A method of releasing a fragrance from a normally solid fragrance-bearing material disposed in a receptacle, comprising the acts of:
forming a fragrance chimney in the solid material to selectively accommodate displacement of fragrance to ambient environment;
heating the solid material in the receptacle thereby rapidly causing release of fragrance from the solid material into the chimney and thence into the ambient environment.

8. A hand-held slender probe for creating a tunnel in a solid body fragrance-bearing candle material comprising:
a distal end having a size which defines the transverse size of a hollow tunnel to be created in the solid body of candle material;
a proximal end to be manually grasped by a user to manipulate the probe to create a hollow tunnel in the solid body candle material whereby upon application of heat to the candle material fragrance is emitted into the tunnel and then into a surrounding ambient environment;
a central portion interposed between the distal end and the proximal end.

9. A hand-held slender probe according to a claim 8 wherein the distal end comprises a hollow annulus by which a solid plug of candle material is captured and removed from the body of the candle material to create the tunnel.

10. A hand-held slender probe according to claim 9, wherein the hollow annulus comprises a distal cutting edge which cuts the solid plug and a hollow chamber which receives and stores the solid plug.

11. A hand-held slender probe according to claim 8 wherein the distal end is solid whereby insertion of the distal end displaces the solid body of candle to form the tunnel.
